(19) United States
(12) Patent Application Publication
(10) Pub. No.: US 2018/0189829 A1
(43) Pub. Date: Jul. 5, 2018

(54) CROSS-CURRENCY CAMPAIGN DELIVERY SYSTEM

(71) Applicant: INTERNATIONAL BUSINESS MACHINES CORPORATION, ARMONK, NY (US)

(72) Inventors: Sachin S. Patwardhan, Pune (IN); Shikha Singh, Pune (IN); Sandip P. Thube, San Francisco, CA (US)

(21) Appl. No.: 15/398,341

(22) Filed: Jan. 4, 2017

(51) Int. Cl. G06Q 30/02; G06Q 20/38; G06Q 20/36

(52) U.S. Cl. CPC G06Q 30/0254; G06Q 20/3678; G06Q 20/381

(57) ABSTRACT

Systems, methods and tools for delivering campaign related messages to users engaging in potential cross-currency transactions. Embodiments of the disclosure combines analytics with data collection techniques to predict potential cross-currency transaction, learn about the user, user's location, the user's native currency type associated with the transaction predicted and obtain conversion rate information to make predictions about the strengths or weaknesses of the user's native currency. The embodiments may direct campaign messages to the user's client device promoting or encouraging cost savings the user may incur by completing the transaction at a favorable time for the currency exchange. The cross-currency campaign delivery system may optimize the offers extended to the user during a messaging campaign by comparing the currency rates being used in the cross-currency transaction to the projected strength of the currency at both the present time and over a projected timeline.

### TECHNICAL FIELD

The present disclosure relates generally to systems, methods and tools for delivering and displaying campaign messages.

### BACKGROUND

Campaign systems operate by generating contact lists based the campaign's criteria and then deliver the campaign's messages and marketing utilizing multiple delivery channels. These delivery channels may include web servers, mobile push notifications and other messaging services. A number of online advertising systems exist for displaying targeted advertisements on web pages. To advertise via such a system, a person associated with the business typically interacts with a series of web pages of the advertising system to set up one or more ad campaigns. During this process, the person typically specifies the text to be included in a particular ad, the URL of a target or “landing” page, ad targeting information for selecting the ad for display (e.g., one or more keywords or keyword phrases), and pricing information that governs how much the business/advertiser will be charged in connection with ad “click-thru” events. The business/advertiser can also typically specify one or more parameters, such as a daily budget and a campaign termination date, for controlling the timing and frequency with which a given ad is displayed.

Once an ad campaign has been created, the advertising system automatically selects the ad for display on the web pages of one or more web sites, and (typically) charges the advertiser for each resulting ad click-thru event. The particular method used by the advertising system to select ads for display may vary widely. For example, in the case of a search request from a user, the advertising system may present the ads of advertisers that have associated their respective ads with a search term or phrase entered by the user. In the case of a request for a relatively static web page, the advertising system may present those ads deemed to be the most closely related to page's textual content.

### SUMMARY

A first embodiment of the present disclosure provides a method for delivering cross-currency campaign messages to a computer system comprising the steps of: collecting, by a processor of the computer system, user activity of a user account linked to the computer system; identifying, by the processor, a cross-currency transaction as a function of the user activity collected; retrieving, by the processor, a projected currency conversion rate; comparing, by a processor, a cost for completing the cross-currency transaction at a present time versus completing the cross-currency transaction at a future time; calculating, by a processor, a currency-conversion conclusion comprising an optimal time to complete the cross-currency transaction as a function of the comparing step; transmitting, by the processor, the currency-conversion conclusion to a campaign management system; receiving, by the processor, a campaign message directed toward the optimal time to complete the cross-currency transaction; and displaying, by the processor, the campaign message on a display device.

A second embodiment of the present disclosure provides a computer system, comprising: a central processing unit (CPU); a memory device coupled to the CPU; and a computer readable storage device coupled to the processor, wherein the storage device contains program code executable by the CPU via the memory device to implement a method for delivering cross-currency campaign messages to the computer system comprising the steps of: collecting, by the CPU of the computer system, user activity of a user account linked to the computer system; identifying, by the CPU, a cross-currency transaction as a function of the user activity collected; retrieving, by the CPU, a projected currency conversion rate; comparing, by the CPU, a cost for completing the cross-currency transaction at a present time versus completing the cross-currency transaction at a future time; calculating, by a CPU, a currency-conversion conclusion comprising an optimal time to complete the cross-currency transaction as a function of the comparing step; transmitting, by the CPU, the currency-conversion conclusion to a campaign management system; receiving, by the CPU, a campaign message directed toward an optimal time to complete the cross-currency transaction; and displaying, by the CPU, the campaign message on a display device.

A third embodiment of the present disclosure provides a computer program product comprising: one or more computer readable hardware storage devices having computer readable program code stored therein, said program code containing instructions executable by the one or more central processing units (CPU) to implement a method for delivering cross-currency campaign messages to a computer system comprising the steps of: collecting, by the CPU of the computer system, user activity of a user account linked to the computer system; identifying, by the CPU, a cross-currency transaction as a function of the user activity collected; retrieving, by the CPU, a projected currency conversion rate; comparing, by the CPU, a cost for completing the cross-currency transaction at a present time versus completing the cross-currency transaction at a future time; calculating, by a CPU, a currency-conversion conclusion comprising an optimal time to complete the cross-currency transaction as a function of the comparing step; transmitting, by the CPU, the currency-conversion conclusion to a campaign management system; receiving, by the CPU, a campaign message directed toward the optimal time to complete the cross-currency transaction; and displaying, by the CPU, the campaign message on a display device.

### BRIEF DESCRIPTION OF THE DRAWINGS

FIG. 1 depicts a schematic view of an embodiment of a system for delivering cross-currency influenced campaign messages consistent with the embodiments of the present disclosure.

FIG. 2 depicts an embodiment of a flow chart describing a system for delivering cross-currency influenced campaign messages.

FIG. 3 depicts a flow chart describing an embodiment of a method for delivering cross-currency influenced campaign messages.

FIG. 4 depicts a block diagram of an embodiment of a generic computer system capable of implementing methods for delivering cross-currency influenced campaign messages consistent with the embodiments described in this application.

### DETAILED DESCRIPTION

### Overview

Embodiments of the present disclosure recognize that currently available campaign delivery systems pushing messages to users, potential clients and computer systems do not identify, analyze or take into consideration the savings and/or costs associated with currency conversion or the fluctuations currency can have on the prices being paid for goods and services. Generally, existing campaign messaging services identify offers or transactions for goods and services that may fit with the interests of a user or potential client. However, currently available campaign systems do not generate promotions or offers affiliated with a campaign message that would advise or take advantage of currency rate fluctuations in cross-currency e-commerce.

Embodiments of the cross-currency campaign delivery system improve upon currently available campaign messaging systems by not only improving the relevance of the campaign messages transmitted to the users and potential clients of the system, but the system can also identify potential cross-currency transactions. The presence of cross-currency transactions may influence the types of campaign messages, promotions, offers and information that may be received by the users or potential customers. Embodiments of the cross-currency campaign delivery system identify potential cross-currency transactions by collecting information about the user from one or more data sources comprising data describing a user or a potential client's predictable transactions. The data sources may include browser activity, social media, system logs, system files, messaging services, forum activity, email data, search engine history, e-commerce wish lists and viewing habits, keystrokes, mouse movements, audio data, and video data.

In some embodiments of the cross-currency campaign delivery system, collected data about the user or potential client may allow for the system to identify a number of potential transactions, the currency type associated with the transaction as well as the type of standard currency the user or potential client typically buys or sells in. If the currency of the potential transaction is different from the standard currency used by the user or potential client, the system may draw the conclusion that a currency conversion may occur in order to complete the transaction. Embodiments of the system may direct campaign messages to the user or client based on the cost savings the user may incur by completing the transaction at a favorable time for the currency exchange. For example, buying an item when the currency purchasing the goods while the conversion rate of the standard currency being used by the client or user is stronger and thus worth more. For instance, in some embodiments, the cross-currency campaign system may examine a user's virtual shopping cart, electronic wallet (e-wallet) or wish list filled with items for potential purchases from one or more online vendors. The cross-currency campaign system may identify one or more pending transactions that may include the performance of a currency conversion to complete. The cross currency campaign system may monitor the currencies associated with the items in the virtual shopping cart and transmit campaign messages to the user indicating the most advantageous time to complete the transaction.

Embodiments of the cross-currency campaign delivery system may optimize offers extended during a messaging campaign by comparing the currency rates being used in the cross-currency transaction and the projected strength of the currency at both the present time and over a projected timeline. The system may retrieve currency projections from banking institutions, lenders, currency traders and other financial institutions and apply the currency projections to the collected data in order to predict the beneficial times for completing a cross-currency transaction. If the currency used to complete the transaction is anticipated to be strongest at the present time and further anticipated to weaken over the projected timeline, then the campaign system may entice users or potential clients with campaign messages informing the users of the savings that may be realized by completing the transaction while the currency in strong. For example, with messages indicating that completing the transaction within a specified time period could save the user a particular percentage of money.

Similarly, the system may also predict that the user's currency being applied to the cross-currency transaction may be weaker at the present moment, but is anticipated to strengthen over the projected timeline. Accordingly, the cross-currency campaign system may target campaign messages in accordance with the shift in currency value. For example, by promoting messages to a user of potential cost savings to entice the completion of the transaction during the period of time that the user's currency has been projected to increase in value. The campaign messages transmitted and displayed by the user may include messages promoting cost savings for future transactions or transactions performed during a particular time frame. To encourage such future transactions during a specified time frame, the campaign messages may promote the cost savings as part of a promotional event that the user may expect to begin on a specified date. For instance, campaign system may predict that a currency may fluctuate in strength by 10% starting next week. The campaign system may transmit campaign messages indicating that a user may save 10% on a purchase starting next week, coinciding with the predicted currency fluctuation.

### System for Delivering Cross-Currency Campaign Messages

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

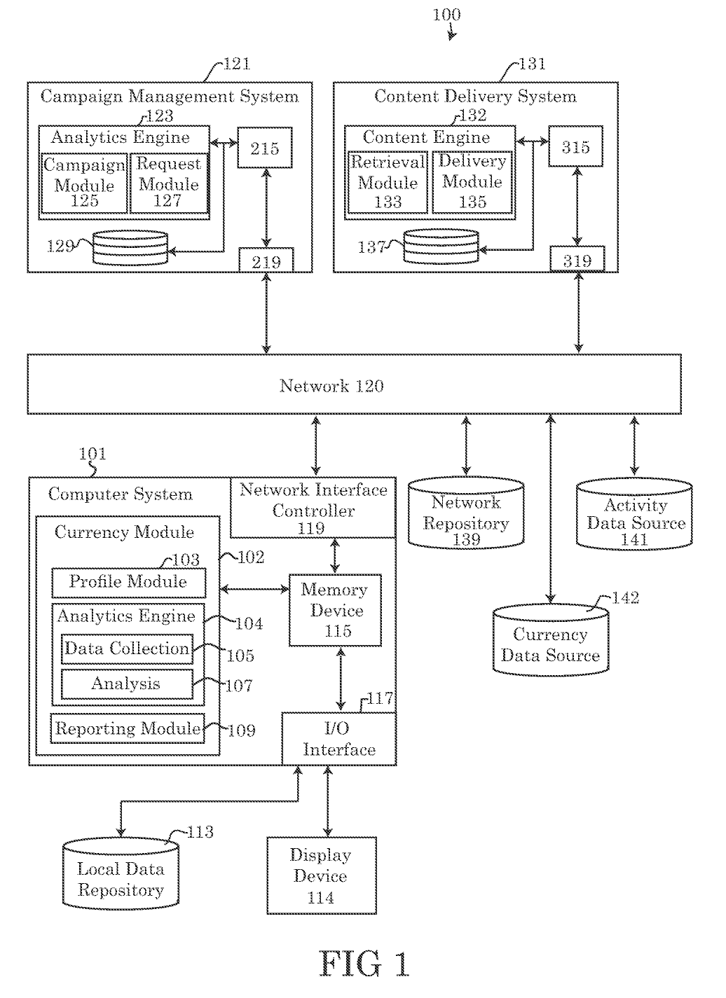

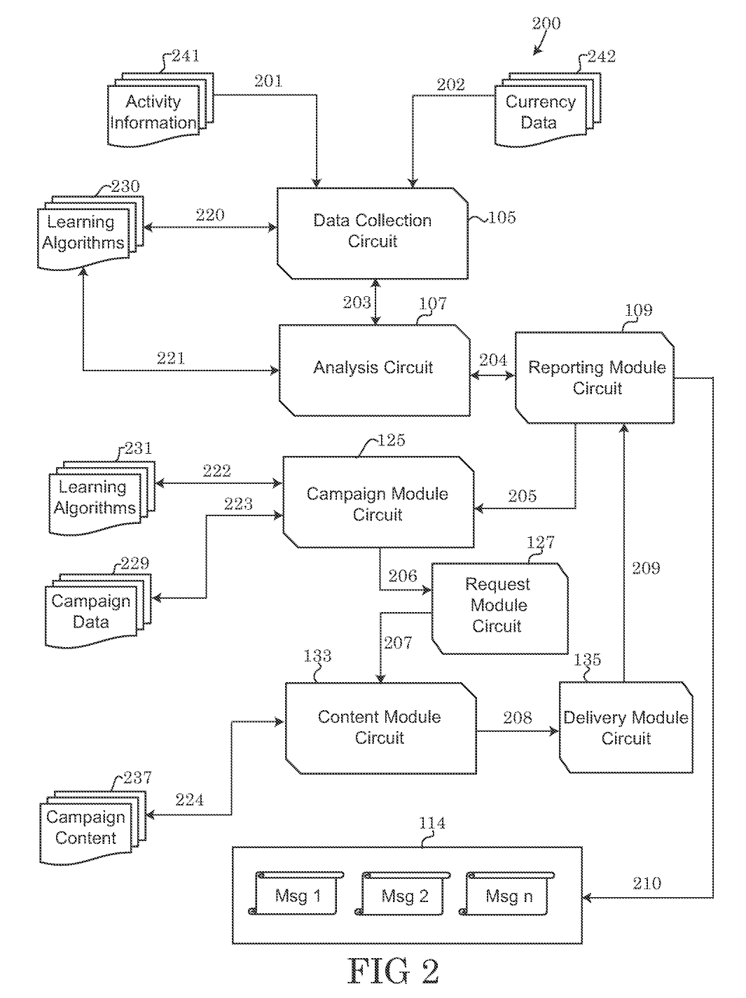

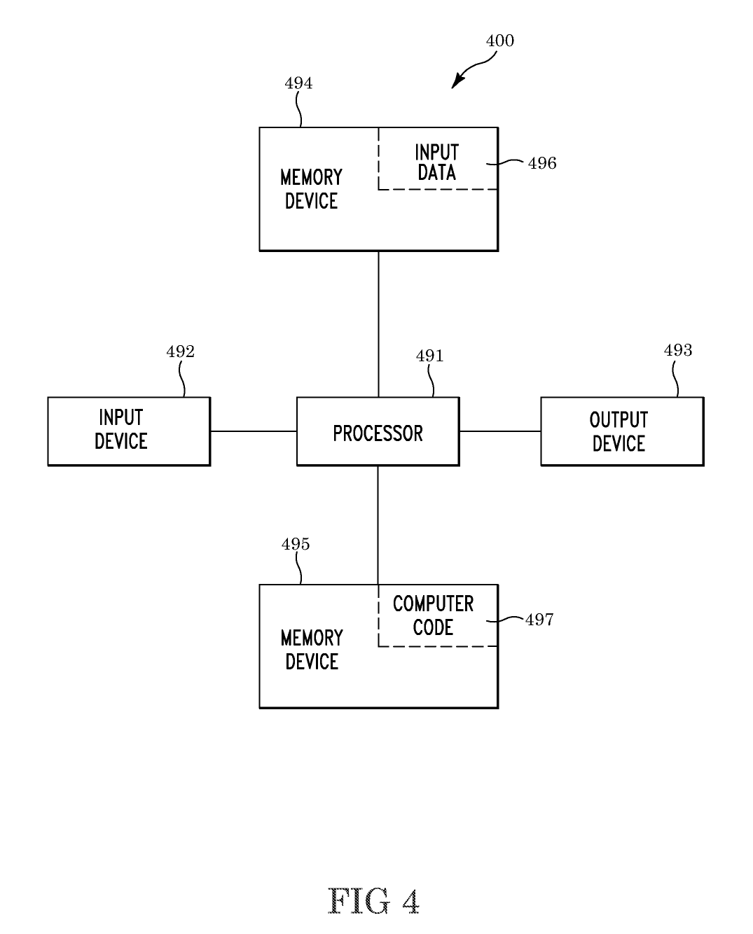

Referring to the drawings, FIG. 1 depicts a block diagram of a cross-currency campaign system 100 (also referred to as “system 100”) for delivering targeted campaign messages to one or more campaign message recipients anticipated or identified by the system 100 to potentially engage in a transaction that may employ the conversion of the message recipient's native currency into a secondary currency in order to complete the transaction. Embodiments of the cross-currency campaign system 100 may comprise a plurality of one or more computer systems 101, 121, 131. The computer systems 101, 121, 131 may each be specialized computer systems, having specialized configurations of hardware, software or a combination thereof as depicted in FIG. 1-2 of the present disclosure and in the embodiments described herein. Embodiments of the computer systems 101, 121, 131 may comprise not only the elements of the systems depicted in FIG. 1-2, but may also incorporate one or more elements of a generic computer system 400 as shown in FIG. 4, described in detail below. Elements of the generic computer system of FIG. 4 may be integrated into each of the specialized computer systems 101, 121, 131 of FIGS. 1-2.

In some embodiments of system 100, the system 100 may include a client device 101. The client device 101 may be any touch point device or computer system capable of receiving input from a user engaging in a cross-currency transaction. Examples of client devices may include but are not limited to desktop computers, mobile communication devices, smart phones, cell phones, laptops, tablet computers, smart watches and glasses, personalized data assistants (PDA) and wireless or internet enabled media devices. In some embodiments, the client device 101 may include a currency module 102. The term “module” may refer to a hardware based module, software based module or a module may be a combination of hardware and software resources. A module (whether hardware, software, or a combination thereof) may be designed to implement or execute one or more particular functions, tasks or routines. Embodiments of hardware based modules may include self-contained components such as chipsets, specialized circuitry and one or more memory devices. A software-based module may be part of a program code or linked to program code containing specific programmed instructions loaded in the memory device 115, 215, 315 of the specialized computer systems 101, 121, 131 of the cross-currency campaign system 100.

Embodiments of the currency module 102, whether hardware, software or a combination thereof may perform the functions and tasks associated with user identification, accessing user accounts, collection of user activity information 241 and analysis of the user activity information 241 in order to identify potential cross-currency transactions predicted to be engaged in by a user of the client device 101. The currency module 102 may be responsible for retrieving currency projections from one or more currency data sources 142 such as banks, brokerage companies and financial institutions. Based on the collection of user activity information and the predicted trends in the currency market, the currency module 102 may draw conclusions about the performance of one or more cross-currency transactions, the optimal time to perform the cross-currency transaction and solicit the user via campaign messages directed toward users as a function of the currency trends predicted by the currency module 102. Embodiments of the currency module 102 may comprise one or more additional sub-modules or engines performing each of the tasks and functions of the currency module 102. For example, the currency module may include a profile module 103, a reporting module 109 and an analytics engine 104 comprising a data collection module 105 and an analysis engine 107, as shown in FIG. 1 of the current application.

The profile module 103 may perform one or more tasks related to identifying and storing information about one or more users of the client device 101. Embodiments of the profile module 103 may create a user account or user profile for compiling user behavior, customized settings and activity history to a centralized location that may be continuously updated, tracked and improved. A user having a created profile may load the user profile into any client device 101 capable of retrieving the user profile information. For example, user profile information may be stored locally on a local data repository 113 connected to each individual client device 101 or in some embodiments, the profile module 103 may store and retrieve user profile information stored remotely. For example, on a network repository 139 or another network accessible computer system 121, 131 on a cloud computing network. Each of the computer systems 101, 121, 131 of the network 120 may be able to access the network repository 139 and thus capable of loading a particular user's profile into memory device 115. Embodiments of the profile module 103 may receive input data from the user operating the client device 101 and in response to receiving the input data indicating the presence of a particular user, the profile module 103 may select the appropriate user profile and load the customized settings into the memory device 115.

Embodiments of the profile module 103 may identify the user of the client device 101 by verifying the identity of the user attempting to access a particular user profile stored by the client device 101. Verification of a user may include a request, made by the profile module 103, for the user to produce one or more types of authentication credentials demonstrating a user's rights to access the requested user profile stored by the profile module 103, a remotely accessible computer system or a network accessible storage device, such as the network repository 139. For example, to verify a user's identity, the user may provide password authentication, smart card authentication or a biometric authentication. For instance, in some embodiments, the profile module 103 may receive biometric data for the purposes of authentication and identification of the user through one or more biometric input devices or a scanning devices attached to the client device 101. Authenticating devices may be visual devices, audio devices or touch sensitive devices. For example, the biometric input devices may be a camera, biometric camera, touchpad and/or microphone for the purposes of facial recognition, iris scanning, fingerprint scanning, voice recognition, hand recognition, signature recognition or other forms of biometric input known by individuals skilled in the art.

A client device 101 having loaded a user profile obtained by the profile module 103 into the memory device 115, may be able to learn about a user's past transactions, behaviors and patterns from historical data tied to the user's profile. In some embodiments, an analytics engine 104 may collect historical data describing user activity from one or more activity data sources 141, local data repositories 113 and network repositories 139 available to the analytics engine 104. Embodiments of the analytics engine 104 may discover, interpret and communicate meaningful patterns in the data received by the client device 101. The analytics engine 104 may utilize simultaneous applications of statistics, computer programming and in some instances data visualization to perform a computational analysis of user activity data. Moreover, the embodiments of the analytics engine may utilize a combination of predictive analytics and web analytics to analyze historical data of a particular user, identify trends in the data and analyze the effects of user generated decisions or events to gain knowledge about the user, potential cross-currency transactions and target campaign messages to users and prospective users likely to engage in cross-currency transactions.

Embodiments of the system 100 may utilize the functionality of the analytics engine 104 to learn and identify patterns in the behavior and routines of the user of the client device 101 and draw conclusions about the user's potential future transactions, a user's location and the standard currencies that a user typically utilizes during the user's transactions. The conclusions and patterns identified by the analytics engine 103 may create a foundation for recognizing transactions that a user may engage in, including potential cross-currency transactions. The system 100, may in turn utilize the conclusions drawn by the analytics engine 104 to deliver campaign messages to entice the user to engage in the cross-currency transactions at an optimal moment in time when the user's currency has the highest value. In particular, the system 100 may utilize the knowledge and conclusions drawn about the user to direct campaign messages with promotions, offers, savings, advice and recommendations about each of the future transaction predicted to occur.

The data collection module 105 may collect and retrieve user activity information 241 in the form of data or data sets from a plurality of activity data sources 141, data marts, knowledge bases, and repositories 113, 139. The user activity information 241 may be collected from locally accessible sources such as a local data repository 113 connected to the input/output interface 117 of the client device 101. The user activity information 241 may also be collected from network accessible sources, such as activity information 241 stored by network accessible computer systems and repository 139. The data repositories 113, 139 may include data generated as a function of the user's activity, interaction with client device 101 and/or interaction with network accessible data sources 141 or networked computer systems that may have stored the activity information to the user profiled loaded by the profile module 103.

The user activity information collected by the data collection module 105 may include information such as key strokes, mouse movements, video data or audio data from an audio and/or video input device (e.g. camera or microphone), internet browsing history, search engine history, e-commerce activity including purchase histories, reviews, pending virtual shopping carts and stored wish lists, application or web application history, social media data, messaging services, SMS messaging, mobile communications, calendar information, phone messaging services, VOIP, email, computer logs, computer files, network logs, and any other sources of data that may be known by a person skilled in the art.

Embodiments of the data collection module 105 may continuously collect or periodically scrape data from each of the accessible activity data sources 141 and/or data storage devices described above. As the amount of data collected by the data collection module 105 increases, more accurate predictions and conclusions may be drawn about the user and the user's activities via the analytics engine 104. The incorporation of new user activity information into the analysis module 105 may assist the analytics engine 104 by allowing the analytics engine 104 to more accurately predict future transactions the user may engage in. In particular, the analytics engine 104 may specifically identify user activity information 241 revolving around potential international or cross-currency transactions that might involve activities between different countries, multiple currencies and currency exchanges in order to complete the transaction.

Embodiments of the data collection module 105 may not only collect relevant information about the user's activity to uncover potential cross-currency transaction that may be targeted for campaign messages by system 100, but in some embodiments the data collection module 105 may further retrieve currency information relevant to each currency predicted to be relevant to the potential cross-currency transactions. Embodiments of the data collection module 105 may access currency information from one or more currency data sources 142 which may be locally stored by the client device 101 or available to the client device 101 via network 120 as shown in FIG. 1. Examples of currency data sources 142 may include currency information collected from one or more financial institutions such as banks, brokerages, financial applications, lenders and government institutions. The currency data 242 may be retrieved from the financial institutions acting as currency data sources 142 with predictions and currency projections made by the financial institutions over a projected timeline in some embodiments. In alternative embodiments, the currency data sources 142 may provide raw currency data 242 that the analytics engine 104 may use, along with one or more statistical models or algorithms, to create currency projection predicting trends in currency values over a selected period of time.

Embodiments of the analytics engine 104, may further include an analysis module 107. The analysis module 107 may be the hardware and/or software component of the analytics engine 104 capable of analyzing the user activity data and currency data 242 collected by the data collection module 105. From the data collected, the analysis module 107 may identify a plurality potential cross-currency transactions predicted to be of interest to the user. The analysis may identify a prospective transaction appearing in the user activity data 241 predicted to be a cross-currency transaction based on user information being compared with the information of the prospective transaction. For example, the analysis module 107, upon identifying the potential transaction, may compare the user's address (which may be provided as part of the user's profile, or derived from the user's activity such as past purchases, shipping addresses, payment information provided in the past, etc.) with the address of the opposing party to the transaction and the proposed currency of the transaction. Based on the user's past activity, embodiments of the analysis engine 104 may predict whether the country of the opposite party to the transaction make deals in a currency standard to the user's previous known transactions or if there is a history of business transactions between the two parties that would suggest a conversion of currencies has occurred previously.

The analysis module 107 of the analytics engine 104 may not only identify the potential cross-currency transactions and the likelihood of a conversion of currency being performed to facilitate the transaction, but in some embodiments, the analysis module may also compare and calculate the optimal transaction dates as a function of the currency projections. The conclusions drawn by the analysis module 107 may be referred to a currency-conversion conclusion. For example, in some instances, the analysis module 107 may identify that a transaction being performed in a particular currency that is not standard or native to the user. The analysis module 107 may further conclude that the strength of the user's native currency is currently much stronger and is projected to weaken in the near future according to projections. In such a situation, the analysis module 107 may draw a currency-conversion conclusion that the system 100 should utilize campaign messages to target the user and promote the completion of the transaction prior to the weakening of the user's native currency.

Conversely, in some embodiments, the analysis module 107 may identify, as a function of the user activity and currency projections, that the user's standard currency may either gain strength in the near future or that the currency that the user's native currency is being converted into may weaken in the near future. Under this circumstance, the user may gain a benefit of completing the cross-currency transaction at a later time when the user's native currency is projected to become more favorable in comparison with the currency of the transaction. The analysis module 107, recognizing that the user may benefit from the increased benefits of the stronger currency in the near future, may target campaign messages to the user's client device 101 encouraging or promoting the completion of the transaction within a particular time frame in the future predicted to favor the conversion of the user's native currency.

For example, in some embodiments, the cross-currency campaign delivery system may identify a potential transaction pending in a virtual shopping cart of an e-commerce website frequented by the user of the e-commerce website. The cross-currency campaign delivery system may analyze the pending transaction, the date the transaction began pending in the shopping cart and the strength of the currency at the time the transaction was queued as well as the current strength of the currencies anticipated for completing the transaction. The system 100 may analyze current trends in both the user's native currency and the currency required for completing the transaction stored by the virtual shopping cart in order to identify the optimal time for completing the transaction. Upon evaluating the pending transaction, the relative currency strengths and the predicted currency trends, the system 100 may transmit one or more campaign messages to the user of the e-commerce website encouraging the user to complete the pending transaction of the virtual shopping cart while the completion of the transaction is most favorable to the predicted strength of the user's native currency. Likewise, if the system 100 anticipates the strength of the native currency of the user to shift in the user's favor further in the future, the campaign messages of the system 100 being transmitted to the user may offer promotions, advice, or encouragement to complete the pending transaction of the virtual shopping cart at a later specified date, in accordance with the optimized cross-currency conclusions of the system 100.

In an alternative embodiment, the cross-currency transaction may be in the form of filling an electronic wallet (e-wallet) with a digital currency that may be paid for using a user's native currency. Similar to the other cross-currency transactions described throughout this application, the system 100 may evaluate the strength of the user's native currency compared with the cost or rate of converting the native currency into an e-currency maintained by the e-wallet. The system 100 may subsequently predict the optimal time for purchasing the e-currency and inform the user about the relative cost savings of refilling the user's e-wallet during a particular time frame while the conversion rates are optimal. The system 100 may report the optimal timing for refilling a user's e-wallet via one or more campaign messages or promotions indicating that the current time is the optimal moment to complete the transaction or that a predicted date in the future may be more optimal (i.e. a date or time range wherein the user's native currency is predicted to increase in strength relative to the e-currency being refilled).

Embodiments of the currency module 102 may further include a reporting module 109. The reporting module 109 may be responsible for the performing the tasks of transmitting the currency-conversion conclusions drawn by the analytics engine 104 and the analytics engine's modules 105,107 over a computer network 120 to the campaign management system 121. As shown in FIG. 1, the client device 101 may be connected to a network 120 via wired or wireless hardware connections. As shown in the exemplary embodiment, the computer system may connect to the network 120 using a network interface controller (NIC) 119. Embodiments of the NIC may implement specialized electronic circuitry allowing for communication using a specific physical layer and data link layer standard such as Ethernet, Fiber channel, Wi-Fi or Token Ring. The NIC 119 may further allow for a full network protocol stack, enabling communication over network 120 to a group of computer systems or other computing hardware devices linked together through communication channels of the network 120. The network 120 may facilitate communication and resource sharing among the computer systems and hardware devices. Examples of network 120 may include a local area network (LAN), home area network (HAN), wide area network (WAN), back bone networks (BBN), peer to peer networks (P2P), campus networks, enterprise networks, the Internet, cloud computing networks and any other network known by a person skilled in the art.

Embodiments of the currency conversion conclusions deduced by the analytics engine 104 may be loaded into the memory device 115 of the client device 101 by the reporting module 109. Once loaded into the memory device 115, the currency conversion conclusions outputted from the analytics engine 104 for each particular prospective cross-currency transaction, may be transmitted by the NIC 119 over network 120 to a second specialized computer system, the campaign management system 121. In some embodiments, the campaign management system 121 may be an ad server, specially configured for serving advertisements and promotional offers for one or more marketing campaigns. Embodiments of the campaign management system 121 may receive the currency conversion conclusions generated by analytics engine 104 via NIC 219. The currency conversion conclusions transmitted to the campaign management system 121 may be loaded into memory device 215.

In some embodiments of the targeted delivery system 100, the campaign management system 121 may include a separate analytics engine 123. The analytics engine 123 of the campaign management system 121, may further analyze the currency conversion conclusions received from computer system 121. Unlike the analytics engine 103 which collected, organized and categorized the user's activity information and currency projections, the campaign module 125 of the analytics engine 123 may compare each of the conclusions drawn by the analysis module 107 with the available campaign messages accessible to the campaign management system 121. The analysis engine 123 may identify and select an appropriate campaign messages stored by the campaign message database 129 that may coincide with the currency conversion conclusions drawn by the analysis module 107 of client device 101.

Embodiments of the campaign message database 129 may organize, tag and categorize each of the campaign messages stored therein in order to be more easily searchable and identifiable to context specific situations. For example, the campaign messages may be tagged with keywords describing the promotion or offer, the time frame for making the offer valid (immediate or at a future date), and the amount of monetary savings that may be realized to the user as indicated by the campaign message. The campaign module 125 may perform the function of querying the campaign message database 129 for currency conversion conclusion loaded in memory device 215, pertaining to one or more potential cross-currency transactions. The campaign module 125 may retrieve the corresponding query results and associate one or more campaign messages with each corresponding potential transaction and currency conversion conclusion. For example, in a situation wherein analysis module 107 identifies the potential cross-currency transaction as beneficial to the user to take advantage of the user's native currency's strength at the present time due to an increase in purchasing power projected to be a particular percentage (x %) greater purchasing power at the present time, where x is a numerical integer identifying the projected increase in purchasing power compared with a second point in time of the future. Embodiments of the campaign module 125 may identify and select a campaign message encouraging completion of the cross-currency transaction at the present time in order to take advantage of the projected savings of x %. For instance, 5%, 10%, 15%, 20%, etc.

In some embodiments, the campaign module 125 may identify each of the relevant campaign messages for one or more of the identified potential transactions. The campaign module 125 may generate a list of the campaign messages to be delivered to the client device 101. The request module 127 of the campaign management 121 system may receive the list of campaign messages scheduled to be delivered to the client device 101 and perform the task of transmitting remote procedure calls over network 120 to the content delivery system 131. Embodiments of content delivery system 131 may receive the remote procedure calls via the NIC 319 connected to the content delivery system 131. In some embodiments, the content delivery system 131 may be a content distribution network (CDN) capable of serving the actual content and graphical data to the client device 101.

In some embodiments, the content delivery system 131 may load into the memory device 315, a content engine 132 which may collect and retrieve the contents of the campaign message, such as the graphical data that may form the campaign messages scheduled to be delivered according to the campaign management system's requests. The content delivery system 132 may store the graphical data and content of the campaign messages in a content data store 137, data mart, or other organized data storage structure. Embodiments of the content engine 132 may include a retrieval module 133. The retrieval module 133 may be tasked with retrieving the content from the content data store 137 in accordance to the remote procedure call of the campaign management system 121, specifying the campaign messages being requested for delivery to the client device 101. In accordance with the remote procedure call, the retrieval module 133 may load the content of the campaign message into memory device 315 and the delivery module 135 may transmit the content via NIC 319 over network 120 to client device 101. The reporting module 109 may display the content of the campaign message received from the content delivery system as a graphical representation on display device 114.

Referring back to the drawings, FIG. 2 provides a flow chart diagram of an embodiment 200 describing the flow and transformation of information of through system 100 for delivering cross-currency campaign messages. Starting at the data collection module, referred to as a data collection circuit 105 in this particular embodiment. The data collection circuit 105 receives user activity information 241 transmitted at line 201 and currency data 242 transmitted over line 202. Embodiments of the activity information 241 being delivered to the data collection circuit 105 may be transmitted from activity data sources 141, network accessible repositories 139 and locally stored repositories 113. Likewise, the currency data 242 being received by the data collection circuit 105 may originate from currency data sources 142, including banks, brokerages, lenders, government databases and other financial institutions.

Embodiments of the machine learning algorithms 230 may assist the analytics engine 104 with improving pattern recognition and computational learning under artificial intelligence. In the embodiments of the system 100, learning algorithms 230 may be improved via transmission of data received from the data collection circuit 105 via line 220, and the learning algorithms 230 may improve or be improved by influencing the analysis of the data collected by the data collection circuit 105. The influence of the learning algorithms 230 on the analysis circuit 107 as well as the feedback by the analysis circuit 107 on the learning algorithms 230 may be shown via line 221.

Embodiments of the data collection circuit 105 may transmit the collected data to the analysis circuit 107 of the analytics engine 104. Through the use of statistics, computer programming, pattern recognition and computational learning, the analytics circuit 107 may apply the learning algorithms 230 to the collected user activity information 241 and currency data 242 to transform the collected data into an identifiable set of predicted cross-currency transactions, wherein each cross-currency transaction may have a cross-currency conclusion associated with the transaction. The transformation of the collected user activity information 241 and currency data 242 manifesting as a currency conclusion may identify a particular trend in the user's native currency as it relates to a particular transaction and an identification of a recommended action for pursuing the transaction. Including whether to proceed with the transaction at the present time based on the currency's strength or predicted decline in the near future, delay the transaction due to predictions of a future increase in the currency's or a predicted future decline in the resulting conversion currency. Embodiments of the analysis circuit 107 may, via line 204 transmit the cross-currency conclusion of each particular transaction from the analysis circuit 107 to the reporting module circuit 109. The reporting module circuit 109 may update the user's profile in some embodiments. The reporting module circuit 109 may also concurrently transmit the cross-currency conclusions determined by the analysis circuit 107 to the campaign module circuit 125 of the campaign management system 121 over network 120, as represented by line 205.

In some embodiments, the analytics engine 123 comprised of the campaign module circuit 125 may utilize a separate set of learning algorithms 231 to improve the identification and selection of campaign messages stored by the campaign message database. The machine learning algorithms 231 may be improved by the patterns and conclusions drawn by campaign module circuit 125 as well as influence the decisions made by the campaign module circuit 125 as the machine learning algorithms 231 improve. The impact of the machine learning algorithms 231 on the campaign module circuit 125 may be represented by line 222. In some embodiments, the campaign module circuit 125, upon receiving the cross-currency conclusions of one or more predicted cross-currency transactions, may query campaign message database 129, select and retrieve campaign message data 229 via line 223. The campaign message data 229 selected by the campaign module circuit may be selected as a function of the cross-currency conclusions and provide a campaign message consistent with the conclusions generated by the analysis circuit 107. The campaign message data 229 may also describe pertinent information about the campaign message scheduled to be delivered to client device 101, including descriptors of the message itself and pointers directing the campaign management system 121 toward the location of the campaign message's content.

Embodiments of the campaign module circuit 125, may, after retrieving the selected campaign message data 231, query the remote module circuit as shown at line 206, to transmit a remote procedure call to the content module circuit over line 207. The remote procedure call may instruct the content module circuit 133 to locate and load the content of the campaign message data 229 for transmission of the content of the campaign message data 229 to the reporting module 109 of the client device 101. The content module circuit 133 may query content database 137 for the campaign message content 237 corresponding to the campaign message data 229 of the remote procedure call. They query and receipt of the campaign message content 237 may be represented by line 224 of embodiment 200. Embodiments of the campaign message content 237 may include graphical representations or other electronic depictions of the campaign message data 229.

Once the campaign message content 237 has been retrieved from the content module circuit 133, the content module circuit 133 may transmit the content 237 to the delivery module circuit as shown by line 208, which may responsible for further transmitting the campaign message content 237 to the reporting module 109 via line 209. The transmission by the deliver module circuit 135 may be performed via NIC 319 and the campaign message content 237 may be transmitted over network 120. Upon receiving the campaign message content 237, the reporting module circuit 109 may display the campaign message content 237 as a campaign message being displayed by the display device 114, as depicted by the transmission over line 210 from the reporting module 109 to display device 114. The campaign messages, depicted as message 1 (MSG1), message 2 (MSG 2) . . . message n (MSG) may be the visible manifestation of the displayed as content on the display device 114, wherein the number of messages may very up to the n^{th} message which may be the last message in a plurality of campaign messages displayed.

### Method for Delivering Cross-Currency Campaign Messages

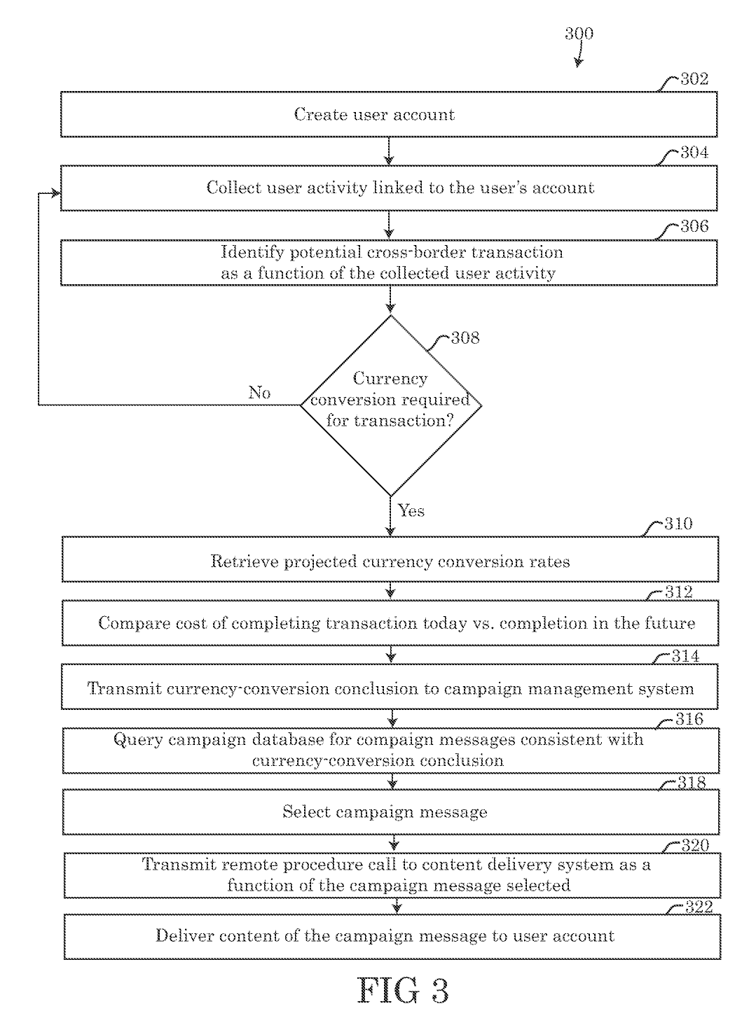

The drawing of FIG. 3 represents an embodiment of a method or algorithm that may be implemented for delivering cross-currency campaign messages in accordance with the cross-currency campaign delivery systems described in FIGS. 1-2 using one or more computers as defined generically in FIG. 4 below, and more specifically by the specific embodiments of FIGS. 1-2. A person skilled in the art should recognize that the steps of the algorithm described in FIG. 3 may be performed in a different order than presented by FIG. 3 and the algorithm may not require all of the steps described herein to be performed. Rather some embodiments may deliver targeted campaign messages using only one or more of the steps discussed below.

The embodiment of the method 300 for cross-currency targeted campaign messages to the client device 101 may begin at step 302. In step 302, the profile module 103 may create a new user account or in some embodiments where the user has previously created a user account, the profile module 103 may retrieve and load the user account into the memory device 115 of the client device 101. To retrieve and load the user account, the user of the computer system may provide one or more forms of authentication credentials to verify the user's identity and access rights.

In step 304, the data collection module of the client device 101 may proceed to collect user activity information from a plurality of activity data sources 141 and any local repositories 113 or network repositories 139 accessible to the client device 101 over network 120. The collected user active information may be linked to the user account loaded by the profile module 103 into memory device 115. The activity of the currency module 103, the data collected and the conclusions drawn by the analytics engine 104 may be stored to the user account and may be recalled by other computer systems capable of the loading the user account.

In step 306 of the method 300, the analysis module 107 may identify potential cross-currency transactions as a function of the user activity data collected by the collection module in step 304 previously. Embodiments of the analysis module 107 through pattern recognition, computer programming, statistical analysis and machine learning, may identify the cross-currency transactions by analyzing user activity data having a transaction assigned to a currency that differs from a currency that the user's activity normally performs transactions with as well as transactions occurring within international countries that differ from the user's country of residence. If, in step 308, a currency conversion is not required for the identified cross-currency transaction, the method 300 may proceed back to step 304 and continue to collect more user activity information for additional cross-currency transaction that may be identified by the analysis module 107.

Alternatively, if in step 308 a potential transaction may be identified by the analysis module 107 as a cross-currency transaction, the method may proceed to step 310. Embodiments of step 310, may include retrieving projected currency conversion rates from one or more currency data sources, accessible to the data collection module 105. In some embodiments the currency conversion rates may be pre-assembled currency projections that may predict the strength or decline of a currency of interest to the computer system for completing the cross-currency transaction, for a pre-determined time period. In alternative embodiments, the data collected from the currency data sources 142 may not be a pre-assembled currency projection but instead may include raw currency data. In such an embodiment, the currency module 102 and more specifically the analytics engine 104 may apply the raw currency data to one or more statistical models or algorithms to create a currency projection that may predict the strength or weakness of a currency over a pre-set period of time.

Based on the currency projections developed in step 310, the analysis module 107 may, in step 312, compare the currency projections of user's native currency and the currency which the native currency is being converted into for completion of the potential transaction. The user's native currency may be compared with the currency projections to identify the cost of completing the transaction at the present time versus the cost of completing the transaction at a future time within the currency projections generated in step 310. The analysis module 107 may create a currency conversion conclusion based on the comparison between the transaction cost of converting the currency today vs. the cost of completing the prospective transaction during the period of time projected by the currency projections. The currency conversion conclusion may include a projected time frame having an optimal time for completing the transaction, an identification of the costs associated with completing the transaction during the optimal time period and the amount of money saved (for example as a percentage) if the transaction is completed during the optimal transactional time period.

In step 314, the currency conversion conclusions describing an optimal time for completing the potential transaction may be transmitted from the analytics module 104 of the client device 101 to a campaign management system 121 via network 120 using NIC 119. Upon receipt of the currency conversion conclusions for a particular potential transaction, the currency conversion conclusion may be loaded into the memory device 215. Subsequently, the campaign module 125 of the analytics engine 123 may further analyze the currency conversion conclusions drawn by analytics engine 104 and in step 316 query campaign message database 129 for campaign message data consistent with the conclusions of the analysis module 107, identifying the optimal time for completing the potential cross-currency transaction and the potential savings associated therewith. After making the query to the campaign message database 127, the campaign module 125 may, in step 318 select a campaign message consistent with the currency conversion conclusions of the analysis module 107. The campaign module may transmit the selected campaign message to a request module 127.

In step 320 of the method 300, the campaign module 125 may transmit a remote procedure call from the campaign management system 121 to the content delivery system 131. The remote procedure call may be transmitted as a function of the campaign message selected by the campaign module 125 and include instructions to the content delivery system 131 instructing the content engine 132 to deliver the content associated with the message data selected in step 318 to the client device 101. Upon receipt of the remote procedure call, the instructions of the call may be loaded into memory device 315. The content engine 132 and more specifically, the retrieval module 133 may query the content database 137 for campaign content associated with the selected campaign message. Once content of the campaign message is identified by the retrieval module 133 and loaded into memory device 315, the delivery module may fulfill the remote procedure call in step 322 and transmit the content of the campaign message retrieved by the content engine 132 over network 120 to the client device 101. The reporting module 109 may receive the transmitted campaign message content and display the content of the campaign message on the display device 114.

### Computer System

Referring to the drawings, FIG. 4 illustrates a block diagram of a computer system 400 that may be included in the systems of FIGS. 1-2 and for implementing methods for delivering cross-currency campaign messages as shown in the embodiment of FIG. 3 and in accordance with the embodiments described in the present disclosure. The computer system 400 may generally comprise a processor, otherwise referred to as a central processing unit (CPU) 491, an input device 492 coupled to the processor 491, an output device 493 coupled to the processor 491, and memory devices 494 and 495 each coupled to the processor 491. The input device 492, output device 493 and memory devices 494, 495 may each be coupled to the processor 491 via a bus. Processor 491 may perform computations and control the functions of computer 400, including executing instructions included in the computer code 497 for tools and programs for delivering cross-currency campaign messages, in the manner prescribed by the embodiments of the disclosure using the systems of FIGS. 1-2, wherein the instructions of the computer code 497 may be executed by processor 491 via memory device 495. The computer code 497 may include software or program instructions that may implement one or more algorithms for implementing the methods for delivering cross-currency campaign messages, as described in detail above. The processor 491 executes the computer code 497. Processor 491 may include a single processing unit, or may be distributed across one or more processing units in one or more locations (e.g., on a client and server).

The memory device 494 may include input data 496. The input data 496 includes any inputs required by the computer code 497. The output device 493 displays output from the computer code 497. Either or both memory devices 494 and 495 may be used as a computer usable storage medium (or program storage device) having a computer readable program embodied therein and/or having other data stored therein, wherein the computer readable program comprises the computer code 497. Generally, a computer program product (or, alternatively, an article of manufacture) of the computer system 400 may comprise said computer usable storage medium (or said program storage device).

Memory devices 494, 495 include any known computer readable storage medium, including those described in detail below. In one embodiment, cache memory elements of memory devices 494, 495 may provide temporary storage of at least some program code (e.g., computer code 497) in order to reduce the number of times code must be retrieved from bulk storage while instructions of the computer code 497 are executed. Moreover, similar to processor 491, memory devices 494, 495 may reside at a single physical location, including one or more types of data storage, or be distributed across a plurality of physical systems in various forms. Further, memory devices 494, 495 can include data distributed across, for example, a local area network (LAN) or a wide area network (WAN). Further, memory devices 494, 495 may include an operating system (not shown) and may include other systems not shown in the figures.

In some embodiments, the computer system 400 may further be coupled to an Input/output (I/O) interface and a computer data storage unit (for example a data store, data mart or repository). An I/O interface may include any system for exchanging information to or from an input device 492 or output device 493. The input device 492 may be, inter alia, a keyboard, a mouse, sensors, biometric input device, camera, timer, etc. The output device 493 may be, inter alia, a printer, a plotter, a display device (such as a computer screen or monitor), a magnetic tape, a removable hard disk, a floppy disk, etc. The memory devices 494 and 495 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 400, and may include any type of transmission link, including electrical, optical, wireless, etc.

An I/O interface may allow computer system 400 to store information (e.g., data or program instructions such as program code 497) on and retrieve the information from a computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk).

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that delivers cross-currency campaign messages, to deploy or integrate computing infrastructure with respect to accessing content of a shared account. Thus, an embodiment of the present invention discloses a process for supporting computer infrastructure, where the process includes providing at least one support service for at least one of integrating, hosting, maintaining and deploying computer-readable code (e.g., program code 497) in a computer system (e.g., computer 400) including one or more processor(s) 491, wherein the processor(s) carry out instructions contained in the computer code 497 causing the computer system to deliver cross-currency campaign messages. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method of accessing content of a shared account. Thus the present invention discloses a process for supporting, deploying and/or integrating computer infrastructure, integrating, hosting, maintaining, and deploying computer-readable code into the computer system 400, wherein the code in combination with the computer system 400 is capable of performing a method of delivering cross-currency campaign messages.

A computer program product of the present invention comprises one or more computer readable hardware storage devices having computer readable program code stored therein, said program code containing instructions executable by one or more processors of a computer system to implement the methods of the present invention.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for delivering cross-currency campaign messages to a computer system comprising the steps of:
collecting, by a processor of the computer system, user activity of a user account linked to the computer system;
identifying, by the processor, a cross-currency transaction as a function of the user activity collected;
retrieving, by the processor, a projected currency conversion rate;
comparing, by a processor, a cost for completing the cross-currency transaction at a present time versus completing the cross-currency transaction at a future time;
calculating, by a processor, a currency-conversion conclusion comprising an optimal time to complete the cross-currency transaction as a function of the comparing step;
transmitting, by the processor, the currency-conversion conclusion to a campaign management system;
receiving, by the processor, a campaign message directed toward the optimal time to complete the cross-currency transaction; and
displaying, by the processor, the campaign message on a display device.

2. The method of claim 1, wherein the step of calculating identifies the cost of completing the cross-currency transaction at the present time as less expensive as a function of the projected currency conversion rate than completing the cross-currency transaction at a further time.

3. The method of claim 2, wherein the campaign message notifies a user that a cost for completing the cross-currency transaction in the present time will save the user a calculated amount of money determined in the calculating step.

4. The method of claim 1, wherein the cross-currency transaction comprises refilling an electronic wallet with a digital currency.

5. The method of claim 1, wherein cross-currency transaction is a pending transaction of a virtual shopping cart or electronic wish list and the campaign message promoting the completion of the cross-currency transaction is transmitted to a user's display device once the optimal time is the present time.

6. The method of claim 1, further comprising the steps of:
receiving, by the campaign management system, the currency-conversion conclusion, the currency-conversion conclusion indicating a preferred time to complete the cross-currency transaction;
querying, by the campaign management system, a campaign database;
selecting, by the campaign management system, a campaign message from the campaign database consistent with the currency-conversion conclusion; and
transmitting, by the campaign management system, a remote procedure call to a content delivery system, the remote procedure call directing the content delivery system to transmit the content of the selected campaign message to the computer system.

7. The method of claim 6, further comprising the steps of:
receiving, by the content delivery system, the remote procedure call;
querying, by the content delivery system, a content database;
selecting, by the content delivery system, the content of the campaign message selected by the campaign management system; and
transmitting, by the content delivery system, the content of the campaign message to the computer system.

8. The method of claim 1, further comprising providing at least one support service for at least one of creating, integrating, hosting, maintaining, and deploying computer-readable program code in the computer system, where the computer-readable program code in combination with the computer system is configured to implement the steps of collecting, identifying, retrieving, comparing, calculating, transmitting, receiving and displaying.

9. A computer system, comprising:
a central processing unit (CPU);
a memory device coupled to the CPU; and
a computer readable storage device coupled to the processor, wherein the storage device contains program code executable by the CPU via the memory device to implement a method for delivering cross-currency campaign messages to the computer system comprising the steps of:
collecting, by the CPU of the computer system, user activity of a user account linked to the computer system;
identifying, by the CPU, a cross-currency transaction as a function of the user activity collected;
retrieving, by the CPU, a projected currency conversion rate;
comparing, by the CPU, a cost for completing the cross-currency transaction at a present time versus completing the cross-currency transaction at a future time;
calculating, by a CPU, a currency-conversion conclusion comprising an optimal time to complete the cross-currency transaction as a function of the comparing step;
transmitting, by the CPU, the currency-conversion conclusion to a campaign management system;
receiving, by the CPU, a campaign message directed toward the optimal time to complete the cross-currency transaction; and
displaying, by the CPU, the campaign message on a display device.

10. The system of claim 9, wherein the step of calculating identifies the cost of completing the cross-currency transaction at the present time as less expensive as a function of the projected currency conversion rate than completing the cross-currency transaction at a further time.

11. The system of claim 10, wherein the campaign message notifies a user that a cost for completing the cross-currency transaction in the present time will save the user a calculated amount of money determined in the calculating step.

12. The system of claim 9, wherein the cross-currency transaction comprises refilling an electronic wallet with a digital currency.

13. The system of claim 12, wherein cross-currency transaction is a pending transaction of a virtual shopping cart or electronic wish list and the campaign message promoting the completion of the cross-currency transaction is transmitted to a user's display device once the optimal time is the present time.

14. The system of claim 9, further comprising the steps of:
receiving, by the campaign management system, the currency-conversion conclusion, the currency-conversion conclusion indicating a preferred time to complete the cross-currency transaction;
querying, by the campaign management system, a campaign database;
selecting, by the campaign management system, a campaign message from the campaign database consistent with the currency-conversion conclusion;
transmitting, by the campaign management system, a remote procedure call to a content delivery system;
receiving, by the content delivery system, the remote procedure call;
querying, by the content delivery system, a content database;
selecting, by the content delivery system, the content of the campaign message selected by the campaign management system; and
transmitting, by the content delivery system, the content of the campaign message to the computer system.

15. A computer program product comprising:
one or more computer readable hardware storage devices having computer readable program code stored therein, said program code containing instructions executable by the one or more central processing units (CPU) to implement a method for delivering cross-currency campaign messages to a computer system comprising the steps of:
collecting, by the CPU of the computer system, user activity of a user account linked to the computer system;
identifying, by the CPU, a cross-currency transaction as a function of the user activity collected;
retrieving, by the CPU, a projected currency conversion rate;
comparing, by the CPU, a cost for completing the cross-currency transaction at a present time versus completing the cross-currency transaction at a future time;
calculating, by a CPU, a currency-conversion conclusion comprising a least expensive time to complete the cross-currency transaction as a function of the comparing step;
transmitting, by the CPU, the currency-conversion conclusion to a campaign management system;
receiving, by the CPU, a campaign message directed toward the optimal time to complete the cross-currency transaction; and
displaying, by the CPU, the campaign message on a display device.

16. The computer program product of claim 15, wherein the step of calculating identifies the cost of completing the cross-currency transaction at the present time as less expensive as a function of the projected currency conversion rate than completing the cross-currency transaction at a further time.

17. The computer program product of claim 16, wherein the campaign message notifies a user that a cost for completing the cross-currency transaction in the present time will save the user a calculated amount of money determined in the calculating step.

18. The computer program product of claim 15, wherein the cross-currency transaction comprises refilling an electronic wallet with a digital currency.

19. The computer program product of claim 18, wherein cross-currency transaction identified in the identifying step is a pending transaction of a virtual shopping cart or electronic wish list and the campaign message promoting the completion of the cross-currency transaction is transmitted to a user's display device once the optimal time is the present time.

20. The computer program product of claim 9, further comprising the steps of:
receiving, by the campaign management system, the currency-conversion conclusion, the currency-conversion conclusion indicating a preferred time to complete the cross-currency transaction;
querying, by the campaign management system, a campaign database;
selecting, by the campaign management system, a campaign message from the campaign database consistent with the currency-conversion conclusion;
transmitting, by the campaign management system, a remote procedure call to a content delivery system;
receiving, by the content delivery system, the remote procedure call;
querying, by the content delivery system, a content database;
selecting, by the content delivery system, the content of the campaign message selected by the campaign management system; and
transmitting, by the content delivery system, the content of the campaign message to the computer system.
